(19) United States
(12) Patent Application Publication
(10) Pub. No.: US 2013/0139669 A1
(43) Pub. Date: Jun. 6, 2013

(54) MASTER SOUND POST GAUGE

(71) Applicant: Karol Siwko, Ocala, FL (US)

(72) Inventor: Karol Siwko, Ocala, FL (US)

(21) Appl. No.: 13/370,249

(22) Filed: Feb. 9, 2012

Related U.S. Application Data
(60) Provisional application No. 61/565,609, filed on Dec. 1, 2011.

(51) Int. Cl. G10D 1/02

(52) U.S. Cl. 84/277

(57) ABSTRACT

This invention provides new means for measuring the length of sound post required in a musical instrument such as violin, viola or cello. It also provides means to measure the angle at each end of the sound post, thus to ensure firm contact with belly and back of the sound box. Special Adjustable Tool is set longer than expected Sound Post. It is also made such, that it can be reduced in length to fit between the Belly and Back of the instrument. It will retain this desired length until it is removed and measured. Each end of this post may also include a swivel type member, such that, while under pressure, it can change its angle and assume position parallel to the plate it is touching. Further, a part of this invention is used to enhance performance of currently available gauge or to redesign this gauge with improvements.

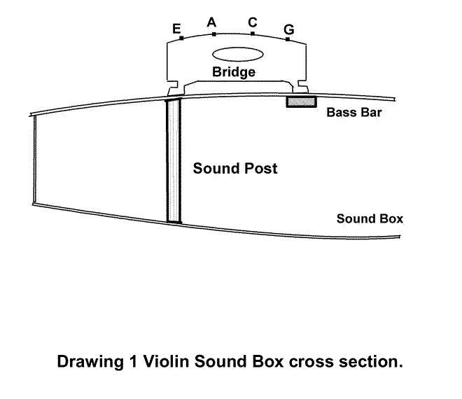

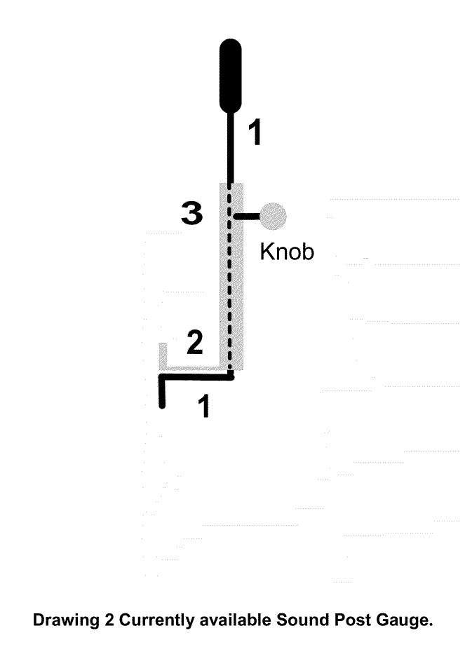

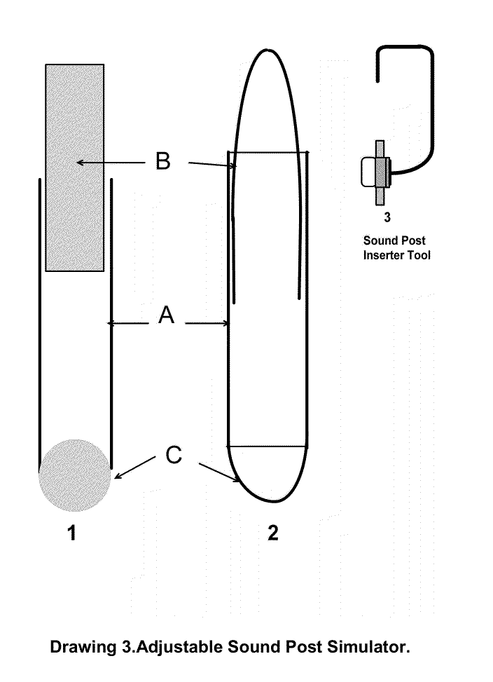

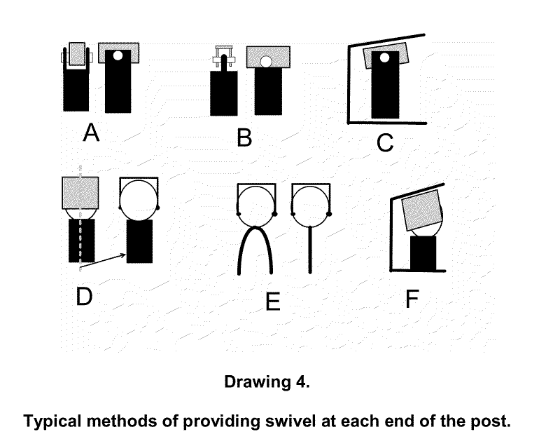

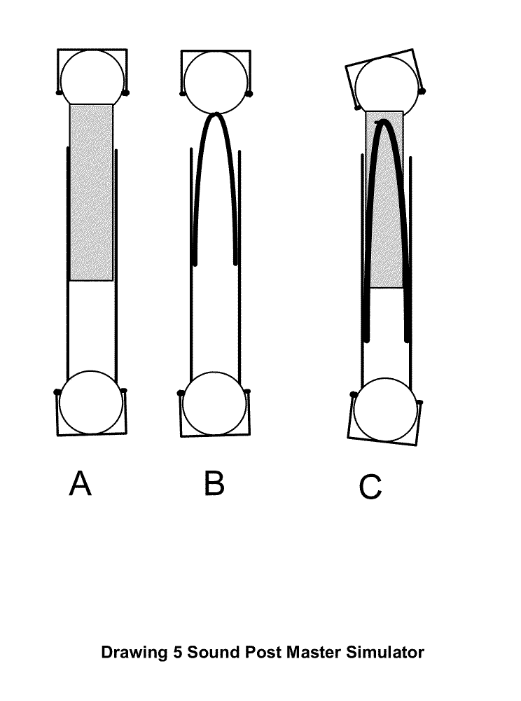

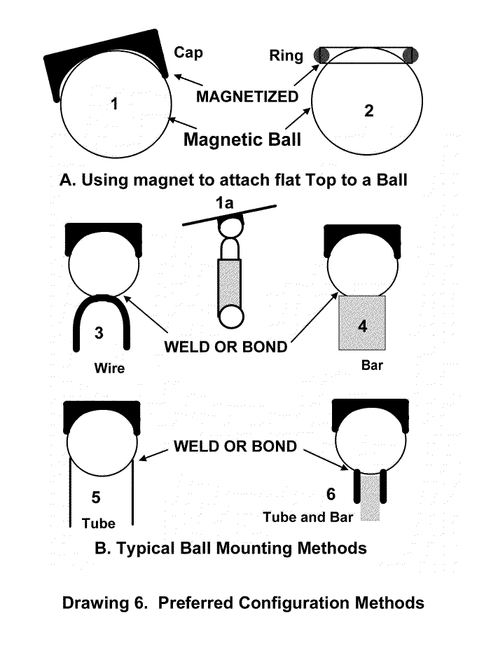

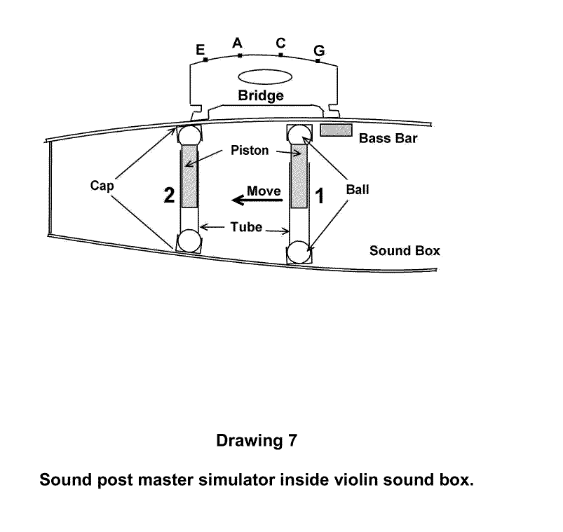

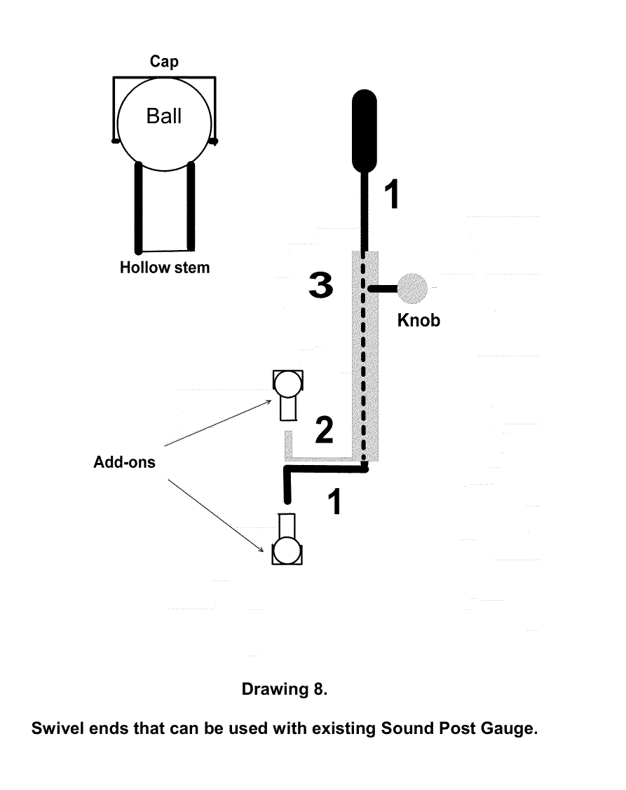

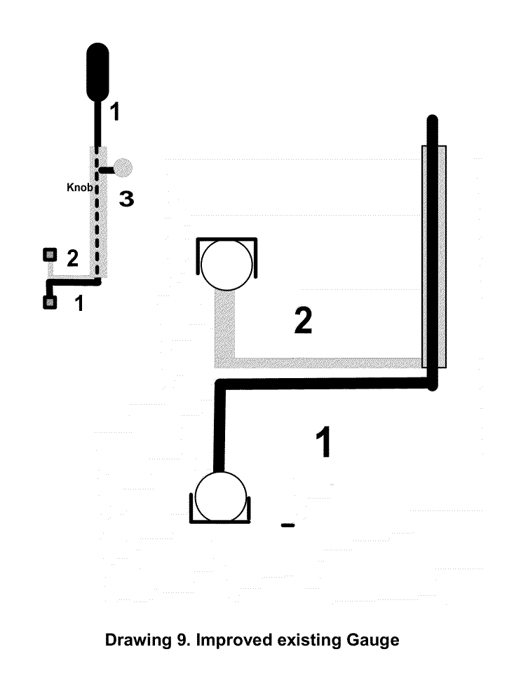

### CROSS REFERENCE TO RELATED APPLICATIONS

This application claims the benefits of U.S. Provisional Patent Application No. 61/565,609 which is incorporated by reference herein.

### FIELD OF THE INVENTION

This invention relates to providing means of measuring the size and shape of violin Sound Post.

### RELATED PRIOR ART

There is a caliper type Violin Sound Post Gauge. Part of the gauge may be inserted into violin Sound Box, and adjusted to measure distance between Top and Bottom. This can be used to find the length of the sound post required for this instrument. No Known patents.

### SUMMARY

This invention provides new means for measuring the length of the sound post and provides means to measure the angle of each end of the sound post, thus to ensure firm contact with belly and back of the violin sound box. First, a special Adjustable Post is set longer than expected Sound Post. It is also made such, that it can be reduced in length to fit between the Belly and Back of the violin. It will retain this desired length until it is removed and measured. Each end of this post may also include a swivel type member, such that, while under pressure, it can change its angle and assume position parallel to the plate it is touching. Further, a part of this invention is used to enhance performance of currently available gauge or to redesign this gauge with improvements.

### BACKGROUND

### Violin Sound Box

Main components of a violin and other similar string instrument include the Sound box, Finger board, Strings and Bridge. Tone or pitch of the sound is controlled by pressing the string against the finger board thus changing the effective length of the string. String is made to vibrate by plucking or bowing it transfers the sound through the Bridge to the top acoustic plate (the Belly) of the Sound Box. This said Sound Box amplifies and projects the sound. Drawing 1 shows cross section inside Violin Sound Box. The inside of the top plate (Belly) of the sound box is reinforced by a Bass Bar permanently glued under the bass side of the bridge. The Sound Post is inserted inside the Sound Box, between the top and bottom acoustic plates, under the treble leg of the bridge. This strengthens the violin and transfers sound vibrations to the bottom plate (Back). Because the belly and the back of violin are not parallel, the required length of the sound post depends on the position in which it needs to be placed. Angle at each end of the Sound Post also needs to conform to contour of the Sound Box. Position of the Sound post has a great effect on quality of sound. Thus proper sound post design is critical.

Drawing 2 illustrates construction of currently available caliper type gauge The gauge has two arms, offset in such way, that they can be introduced inside the sound box via F hole. Once in the desired position, the arms of the gauge are moved away from each other until they stretch between the belly and back of the sound box. The tool is then locked and withdrawn showing the length necessary for the new sound post.

### BRIEF DESCRIPTION OF DRAWINGS

Drawing 1 Violin Sound Box cross section.

Drawing 2 Currently available Sound Post Gauge.

Drawing 3. Adjustable Sound Post Simulator.

Drawing 4. Typical methods of providing swivel at each end of the post.

Drawing 5 Sound Post Master Simulator

Drawing 6 Preferred Configuration Methods

Drawing 7 Sound post master simulator inside violin sound box.

Drawing 8 Swivel ends that can be used with existing Sound Post Gauge.

Drawing 9 Improved existing Gauge

### DETAILED DESCRIPTION OF NEW INVENTION

Principle of Operation

Drawing 3 shows a new approach to find the dimensions required for the Sound Post. Here a simulated post is used and introduced into the Violin Sound Box using a Sound Post Inserting/Removing Tool (detail 3). The basic Sound Post Simulator consists of at least two parts that can slide against each other and are held together by friction.

Practical Approach

Drawing 3 shows details of two variations. 1, telescopic type assembly, where a bar or tube (Detail B) is inserted into a larger tube (A) and held together by friction. The assembly is expanded to a length slightly longer than that required for new Sound Post. When introduced into the Violin Sound Box and maneuvered into desired position, when in contact with Belly and Back of the Sound Box, the two members will close to the desired length and stay in this condition upon withdrawal. Optionally a spring wire or ribbon is bent and inserted into a tube; this assembly again can acquire and hold the required dimension after achieving contact with the belly and back of violin sound box. Numerous other variations are now obvious, like plates or scissor type connection of two members held together by friction. Additional element can be added (Draing 2 Detail C) to the free end of the tube (A). Part C can be either a ball, rod or bent wire, to make it easier to slide against violin sound box surface. This part (C) can also be permanently fixed by bonding to part A, or by crimping part A to permanently capture part C.

Swivel Ends

The usefulness of this type of Sound Post Simulator can be further enhanced by adding swivel member at each end. Because the belly and back of violin are not parallel, the swivel end will measure the angle at which each end of the sound post has to be cut, thus ensure proper fit of the sound post. Drawing 4 shows typical options for building a swivel end. Figs A and B show variations of a bar attached to the end of corresponding member. Fig C shows how this would deflect by contact with a plate. Drawing 4 D shows how a ball can be attached to the sliding rod; a properly fitted cap will deflect when in contact with an angled plane. Drawing 4 E shows a special case where a preformed spring wire is used.

Ball configuration. Drawing 5 shows Sound Post Master Simulator variations. A, where the ball is attached to a plunger forming telescopic type assembly. B utilizes preformed spring wire to provide controllable sliding friction. In both cases the bottom ball is fixed to the main post. This does not exclude option making sliding bottom member. Drwg 5c shows the top member consisting of a tube with spring added to more accurately control friction force.

Drawing 6. Describes preferred configuration method in more detail. Here Drwg 6, detail 1 demonstrates a ball made of magnetic material (such as steel) with a magnet cap. The cap magnet will stay attached to the ball and can slide easily along the surface of the ball, thus acquiring variable angle relative to the rest of the assembly. Detail 2 shows a magnet in form of a ring. Because dimensions of sound post are relatively small, using a magnet cap or ring makes it possible to attach a metallic plate after withdrawal (Detail 1a) which makes it easier to read the angle after withdrawal. The ball can be attached to the tube, rod or spring using any standard method, either welding or bonding, Details 3, 4, 5 and 6.

How it works.

Drawing 7 Demonstrates procedure. First, the Simulator is extended to be slightly longer than expected final length of the sound post. Second, it is then introduced into the highest portion inside violin sound box using the sound post inserter. Third, it is maneuvered carefully to the required position, where it will assume proper dimensions. Finally it is carefully withdrawn and its measurements used for final sound post trimming of the new sound post.

Existing sound post gauge.

Drawing 8 shows typical Swivel that can be attached to existing sound post gauge. Any type of swivel can be made to attach to the existing gauge; may be either properly designed or simply tied or taped to the gauge. Typical ball assembly shown in drawing 6/detail 6, where ball is attached to a short length of tubing is made to fit the dimensions of the existing gauge.

Improved Caliper Gauge

The Caliper Gauge can also be redesigned to accept swivels. Drawing 9 shows improved design of current sound post gauge. Current sound post gauge can be designed to include swivel or a ball with cap to each arm. A ball is bonded or welded to each end of Caliper Gauge arm, a cap or magnetic ring used in previously described manner.

1. A measuring gauge consisting of two or more elements held together but capable to be moved relative to each other and retain dimension in that position. When introduced to a position inside the Sound Box of a string musical instrument such as Violin, Viola or Cello the said gauge can assume dimension to conform to dimensions of that instrument at that said position.

2. As in claim 1 where the first part of the gauge is a tube and second part is a rod that fits inside the tube and capable to slide to increase or decrease dimension of the gauge.

3. As in claim 2 where second part is a smaller tube that fits inside the first part.

4. As in claim 1 where the first part of the gauge is a tube and second part is made of spring material

5. As in claim 1 where free end of the gauge has a third element attached to reduce friction.

6. As in claim 1 where a swivel is attached to the free end of each element of the gauge.

7. As in claim 6 where the swivel consists of a bar rotating around a pin.

8. As in claim 6 where swivel consists of a ball with movable cap attached.

9. As in claim 8 where each ball is made of magnetic material and caps are magnetized to stay attached to the ball.

10. As in claim 8 except the ball is magnetized and cap is made of magnetic material.

11. As in claim 8, having both caps and balls magnetized.

12. As in claim 9 where cap is in form of ring.

13. A ball made of magnetic material and a magnetized cap attached by magnetic force.

14. As in claim 13 where cap is in form of ring

15. As in claim 13 where additional element is added to enable assembly to be attached to other instruments.

16. A Caliper type gauge with built in Swivels.

17. As in claim 16, where the swivels include magnetic balls and caps.
